(19) United States
(12) Patent Application Publication
(10) Pub. No.: US 2002/0010783 A1
(43) Pub. Date: Jan. 24, 2002

(54) System and method for enhancing operation of a web server cluster

(76) Inventors: Leonard Primak, New York, NY (US); John Gnip, Rego Park, NY (US); Gene R. Volovich, Old Greenwich, CT (US)

Correspondence Address: C. Andrew Im, Esq., FULBRIGHT & JAWORSKI L.L.P., 666 Fifth Avenue, New York, NY, 10103, US

(21) Appl. No.: 09/728,270

(22) Filed: Dec. 1, 2000

Related U.S. Application Data
(63) Continuation-in-part of application No. 09/565,259, filed on May 5, 2000.
(60) Provisional application No. 60/202,329, filed on May 5, 2000.
(60) Provisional application No. 60/201,810, filed on May 4, 2000.
(60) Provisional application No. 60/169,196, filed on Dec. 6, 1999.

(51) Int. Cl. G06F 15/16; G06F 17/00; G06F 15/173

(52) U.S. Cl. 709/228; 709/226

(57) ABSTRACT

A distributed system and method for balancing connection load among servers in an asymmetric or heterogeneous server cluster. Each server includes a load balancing module for determining whether its server can accept a new client request. Additionally, the distributed system directs a client request for data to a server having the latest version of the requested data.

### RELATED APPLICATION

This application is a continuation-in-part of the U.S. provisional patent application Ser. No. 60/202,329, filed May 5, 2000, a continuation-in-part of U.S. provisional patent application Ser. No. 60/201,810 filed May 4, 2000, and a continuation-in-part of U.S. patent application Ser. No. 09/565,259, filed May 5, 2000, which is a continuation-in-part of U.S. provisional patent application Ser. No. 60/169,196, filed Dec. 6, 1999, each of which are hereby incorporated by reference in their entirety.

### FIELD OF THE INVENTION

The invention relates to the field of digital data packet management. More specifically, the invention relates to the regulating of data flow between a client computer and a cluster or group of data servers.

### BACKGROUND OF THE INVENTION

The evolution over the past twenty years of digital communications technology have resulted in a mass deployment of distributed client-server data networks, the most well known of which is the Internet. In these distributed client-server networks, clients are able to access and share data or content stored on servers located at various points or nodes on the given network. In the case of the Internet, which spans the entire planet, a client computer is able to access data stored on servers located anywhere on the Earth.

With the rapid proliferation of distributed data networks such as the Internet, an ever-increasing number of clients from around the world are attempting to connect to and access data stored on a finite number of servers. For example, web site owners and/or operators deploying and maintaining servers containing web pages from their popular web sites are finding it increasingly difficult to ensure that all requests for data and/or access can be satisfied. Each server can support only a finite number of concurrent client connections based on the server's computational, storage and communications capacity. When the number of client requests for content or data (i.e., connection requests) exceeds the server's capacity, the clients' connection requests are generally refused or dropped shortly after establishing connections, often in midstream of receiving the requested content. In extreme cases, the number of client requests for content may overload or overwhelm the server as to effectively disable the server, i.e., knock the server out of commission.

As a partial solution to this problem, the web site owners and/or operators typically deploy multiple mirrored servers, each server having identical content. The mirrored servers are usually connected to the same local area network and are collectively referred herein as a server cluster. In conjunction with the multiple mirrored servers, the web site owners and/or operators also employ a load balancer to distribute the load among the mirrored servers. That is, when a client request a connection to one of the servers in the server cluster, the cluster's load balancer processes the request to evenly spread the load (i.e., connection requests) among the servers in the server cluster. Based on information regarding the condition of each server in the server cluster, the load balancer facilitates a connection between the client and a server that is capable of handling the client's request.

An inherent drawback of this load balancing approach of the prior art is that they all utilize a central load balancer. Whether the load balancer is a dedicated hardware appliance or a general-purpose computer running load balancing software, all of the prior art solutions require that a client's connection request be first received and processed by a load balancer before the request can be directed to a server. Accordingly, the maximum rate at which the entire server cluster can receive and respond to client requests is limited by the throughput of the load balancer. Hence, if the load balancer's capacity is exceeded, the requests can be ignored or dropped even if the server cluster has sufficient capacity to process the requests. Another inherent drawback of the prior art centralized load balancing system is that the entire server cluster can be rendered inoperative if the central load balancer fails.

Applicant's pending patent application Ser. No. 09/565,259, filed May 5, 2000, describes a distributed load balancing solution for homogeneous server clusters, which overcomes the above mentioned drawbacks of the prior art, which is incorporated herein in its entirety. In homogeneous server clusters, the member servers are interchangeable and each server contains substantially the identical content (e.g., *.HTML or *.CGI).

An ever-increasing demand by Internet users for diverse content has prompted Internet operators (i.e., web sites, ISP's and ASP's) to deploy heterogeneous server clusters composed of servers having different data types. Heterogeneous server clusters, also known as asymmetric clusters, are composed of multiple server groups, where each group contains at least one server and all the servers in a group contain substantially identical content. That is, each group of servers in a cluster stores different content. Heterogeneous server clusters are particularly useful for storing content in a number of different content formats, such as HTML, CGI, streaming audio or video, etc. Since each content format has different storage and transmission characteristics and requirements, it is inefficient for web site owners and/or operators to employ a single server to provide data in various different formats to clients. When diverse content in a variety of data formats is required, it is desirable to divide the server cluster into groups of servers, where each group of servers processes content requests for a limited number of data format, such as one or two particular data formats. For example, a commercial web site having content in numerous formats may divide the server cluster into three groups of servers: the first group providing only HTML content, the second group providing only CGI content, and the third group providing only streaming audio and video content.

Content must be updated in real-time on many of today's commercial web sites, and with the increasing complexity and number of servers in the server clusters used by these sites, the prior art load balancing system often direct a client's request to a server where the requested content is either being updated or is stale. Although some of the prior art load balancing system consider the format or type of content being requested, none of the prior art load balancing system can detect or determine which servers contain the most recent version of the content, and which servers contain stale data and require updating. Therefore, although the prior art load balancing system can direct a client's request to the appropriate server group, none of the prior art load balancing system can assure that the client is being directed to a server with the most recent version of the requested content.

### OBJECTS AND SUMMARY OF THE INVENTION

Therefore, it is an object of the present invention to overcome the disadvantages of the above-described load balancing system by providing a distributed system and method for balancing client connection load among the servers of a heterogeneous server cluster.

Another object of the present invention is to provide a system and method of directing a client's request for data to a server having the latest version of the requested content.

A further object of the present invention is to provide a content updating and distribution system and method which works collaboratively with the distributed load balancing system of the present invention.

The present invention is a computer network load balancing and content distribution system, which is highly scalable and optimizes packet throughput by dynamically distributing client connections among appropriate servers in a server cluster.

In accordance with an embodiment, the present invention includes a server cluster having a plurality of server groups, where each group has at least one server. All servers in the cluster have a common network address, and are connected to a network such that each server receives a client's connection request at substantially the same time. Each server has a load balancing module which generates a connection value for each connection request received by the server. A particular server in the server cluster accepts and processes the network connection request based on the computed connection value of the request. That is, the cluster has range of connection values and each server is associated with a non-overlapping sub-range of connection values associated with the cluster and accepts only connection requests having connection values within its associated sub-range. Each server's sub-range is dynamically adjusted based on its available capacity, where the size of a server's sub-range relative to the entire range is approximately proportional to the server's available capacity relative to the entire cluster's available capacity. The load balancing modules on each of the server in the cluster communicate information relating to their server's available capacity to each other.

Upon establishing an initial connection with a client, a server according to the present invention includes a reading module for reading the client's request in order to determine whether it has the requested content. If the requested content does not reside on the accepting server or a more recent version of the content can be found on another server in the cluster having sufficient available capacity to accept a connection from the client, the accepting server redirects the client connection request to that other server, which is referred to herein as a destination server. Otherwise, if the accepting server has the requested content, the accepting server accepts the request and transmits the requested content to the client.

In accordance with another embodiment, the distributed load balancing system of the present invention supports persistent sessions using cookies and/or secure sockets layer (SSL) identification tags. The load balancing module of the present invention recognizes cookies and SSL identification tags, and directs the connections to the appropriate server or group of servers based on those recognized cookies and SSL tags.

Working in conjunction with the load balancing system, a content distribution system of the present invention distributes and updates content to servers in a server cluster. The content distribution system includes a storage area for storing the content to be distributed, a file transfer module for copying the content to servers in the cluster, and data tables for storing information regarding the freshness (e.g., version number, last edit or updated date, etc.) and availability of content stored on each server in the cluster.

Various other objects, advantages, and features of this invention will become readily apparent from the ensuing detailed description and the appended claims.

### BRIEF DESCRIPTION OF THE DRAWINGS

The following detailed description, given by way of example, and not intended to limit the present invention solely thereto, will best be understood in conjunction with the accompanying drawings:

FIG. 1 is a diagram illustrating a heterogeneous server cluster in accordance with an embodiment of the present invention;

FIG. 2 is a diagram illustrating a client computer establishing a connection with a server in the server cluster in accordance with an embodiment of the present invention;

FIG. 3 is a diagram illustrating a client connection being redirected from one server to another in the server cluster in accordance with an embodiment of the present invention;

FIG. 4 is a diagram showing an example of a data flow when a client connection is redirected from a first server to a second server;

FIG. 5 is a diagram showing range and sub-range values for servers within a server cluster in accordance with an embodiment of the present invention; and

FIG. 6 is a diagram showing a content distribution system in accordance with an embodiment of the present invention.

### DETAILED DESCRIPTION OF THE INVENTION

The present invention is readily implemented using presently available communication apparatuses and electronic components. The invention finds ready application in a private or public communications network utilizing a heterogeneous server cluster. It is appreciated that the communications network can represent the Internet, a computer network, wireless network, a satellite network, a cable network or any other form of network capable of transporting data locally or globally.

### Server Cluster Configuration

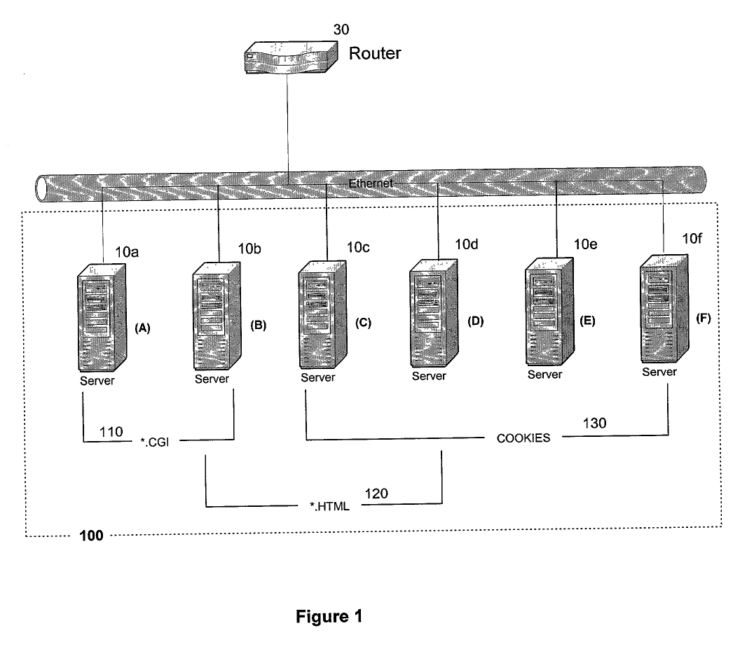

Turning now to FIG. 1, there is illustrated an example of a heterogeneous server cluster 100 comprising: a first group of servers 110 containing *.cgi content, such as servers 10a and 10b; a second group of servers 120 containing *.html content, such as servers 10b to 10d; and a third group of servers 130 for processing cookie sessions, such as servers 10e and 10f. All the servers 10 are connected to a common router 30. Although not shown in FIG. 1, the router 30 receives an inbound client request and multicasts the received request to all the servers 10 in the cluster 100. As exemplified by the server 10b, the same server may belong to more than one group within the cluster. Whether a server belongs to a particular group is determined by the content stored on that server. Server 10b belongs to both *.cgi group 110 and *.html group 120 because it contains content in both *.cgi and *.html formats. Whereas other servers containing content in only a single format belong to only one of the three groups in the cluster 100.

Although FIG. 1 shows only one router 30, its is appreciated that multiple routers can be used in a cascading and partially overlapping configuration as shown in Applicant's prior patent application, Ser. No. 09/565,259, which is incorporated herein in its entirety.

### Establishing an Initial Connection

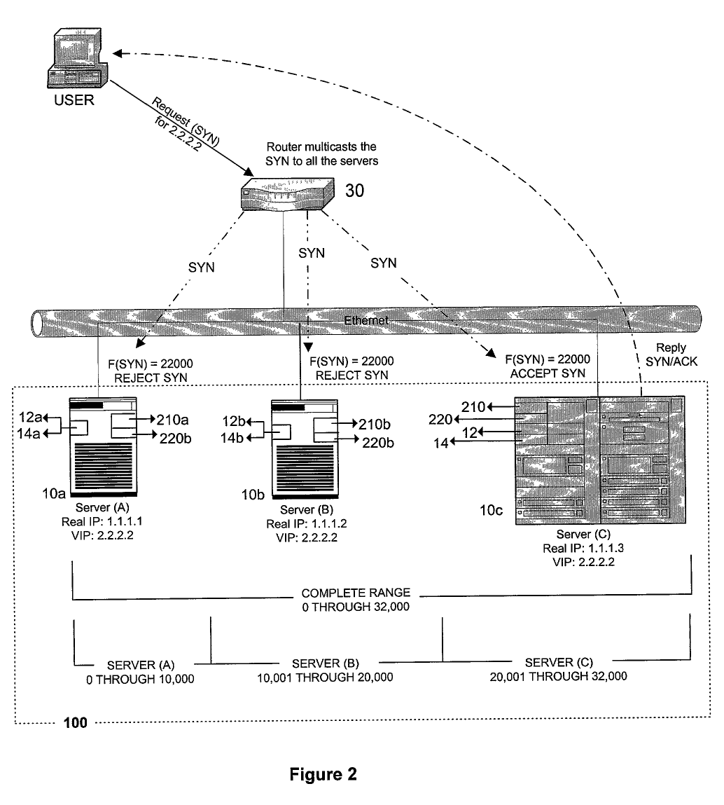

Turning now to FIG. 2, there is illustrated an example of a client computer 60 establishing a connection with a load balanced server cluster in accordance with an embodiment of the present invention. The load balancing techniques disclosed in applicants' pending patent application Ser. No. 09/565,259 is used to load balance the client computer's 60 initial connections to the heterogeneous server cluster of the present invention. On initiation, the router 30 multicasts or broadcasts an address resolution protocol (“ARP”) packet to all the servers in the cluster 100. The ARP packet is used to dynamically bind the virtual IP address 2.2.2.2 of the cluster 100 to the real IP addresses of the servers 10 in the cluster 100. In response to the ARP packet, the servers 10 respond with a special multicast address, such as 01:00:5E:75:C9:3E/IP 224.117.201.62, and not their real MAC (media access control or hardware ethernet) address to the router 30. The router 30 stores the real IP addresses of the servers 10 in its ARP cache, and all incoming packets addressed to the virtual IP address 2.2.2.2 are thereafter multicast to the corresponding real IP addresses of the servers 10.

In accordance with an embodiment of the present invention, each server 10 includes a receiving module 210 for receiving a request and a load balancing module 12 for evaluating or determining whether to pass the client request received by the server to the server's TCP/IP stack. Upon receipt of a client request by the receiving modules of the servers 10, only one of the load balancing modules 12 residing in the servers 10 passes the client request to its TCP/IP stack, thereby insuring that the requesting client establishes connection with only one server 10 in the cluster 100. That is, the load balancing modules 12 residing in the other servers 10 in the cluster 100 discard the client request. In accordance with an aspect of the present invention, each load balancing module 12 evaluates a client request by assigning the client request a connection value. The connection value is a substantially random number having an equal probability of being anywhere within a fixed range, e.g., 0 to 32,000. For example, the loading module 12 can generate the connection value using a hashing function on a predefined portion of the data packet comprising the request. Since each load balancing module 12 performs the same hashing function on a given request, the same connection value is generated by all the load balancing modules 12 for each request.

A load balancing module 12 permits its corresponding server to accept client requests (i.e., establish a connection or pass the requests to the TCP/IP stack) having certain connection values. For example, as shown in FIG. 2, the load balancing module 12b residing in the server 10b accepts only requests having connection values from 10,001 to 20,000. If the client's request has a connection value of 22,000, then the load balancing module 12c passes the SYN packet associated with the client's request to the TCP/IP stack of the server 10c. The synchronizing segment (SYN) is the first segment sent by the TCP protocol and is used to synchronize the two ends of a connection in preparation for opening a connection. Whereas the load balancing modules 12a and 12b discard the SYN packet because the connection value is outside their acceptable range of connection values.

Each server is assigned a range of connection values as a function of its available capacity in relation to the overall available capacity of the cluster. That is, a server having a greater capacity to accept new requests for connection is assigned a greater number or range of connection values. In accordance with an embodiment of the present invention, each server 10 includes an agent 14 that intermittently broadcasts information regarding the available capacity or connection availability of its associated server to other servers 10 in the cluster 100. Preferably, each server stores the available capacity information of other servers in the cluster 100. A server's connection availability is directly proportional to its overall available capacity and inversely proportional to its current connection load. In other words, the range of each server's assigned connection value is substantially proportional to the server's connection availability relative to the overall connection availability of the cluster 100. For example if a server 10a has thirty percent (30%) of the connection availability of the cluster 100, then thirty percent (30%) of the cluster's connection values will be assigned to the server 10a. Preferably, each server's assigned range of the connection values is continuously updated as a function of its available capacity or connection availability, which may change over time.

If a server becomes inoperative or disabled, the connection values of the disabled server is assigned to the remaining servers in the cluster 100. For example, if server 10a is disabled and each remaining server now has fifty percent (50%) of the available capacity, then the servers 10b and 10c are now respectively assigned connection values from 0 to 16,000 and 16,001 to 32,000. Also, during a transition period wherein the servers are assigned new range of connection values, a server's range of connection values may temporarily overlap with another server's range, i.e., a connection value may be assigned to more than one server. In such a scenario, the connection request may be accepted by two servers, but only one connection will be generally established since most conventional network protocols have mechanism to resolve such conflicts. For example, under the TCP/IP protocol, if two servers accept a client's connection request and respond by transmitting their own SYN acknowledgement (ACK) packets to the client computer 60, the client computer 60 will only accept one SYN ACK packet and reject the other, thereby establishing a connection with only one server.

### Redirecting Connection

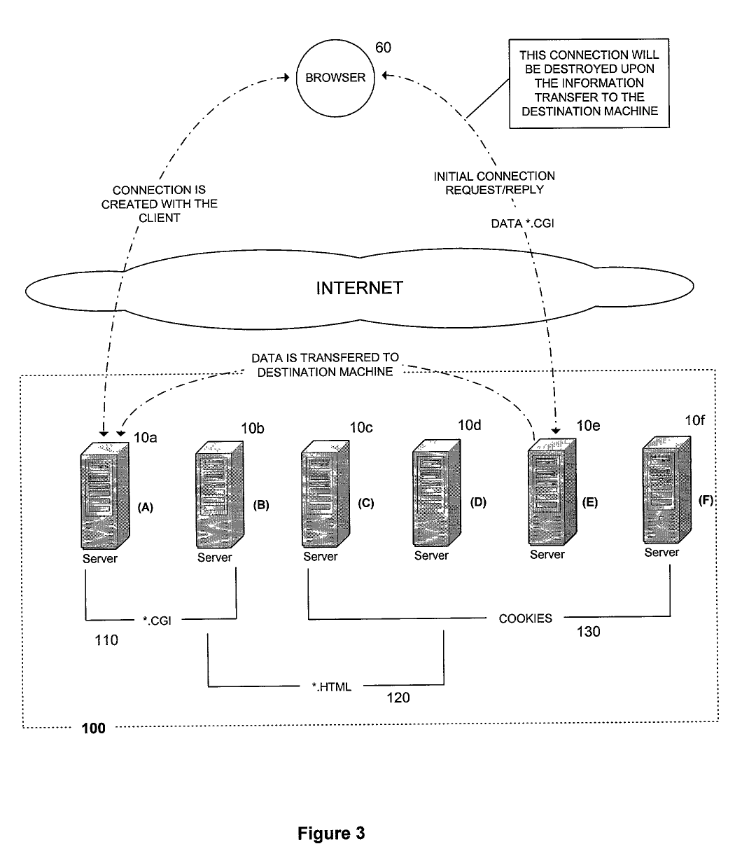

Turning now to FIG. 3, there is illustrated an example of a client connection being redirected from one server to another in the server cluster in accordance with an embodiment of the present invention. In FIG. 3, the server 10e (referred to herein as the original server) redirects a client's 60 connection request to a second server 10a (referred to herein as the destination server). After a connection is established between the client 60 and the server 10e, the client 60 sends several data packets, typically known as PUSH( ) packets, to the server 10e. The PUSH( ) packets collectively form a header which identifies the requested content of the client 60. The server 10e includes a reading module 220 (FIG. 2) for reading the header (i.e., the PUSH ( ) packets) and determining whether its storage device (not shown) has the requested content. For example, if it is determined that the requested content is available from the server 10e, the load balancing module 12e on the server 10e permits the server 10e to transmit the requested content to the client 60.

However, if the requested content is a CGI script and resides only in the *.cgi group 110 (the servers 10a and 10b). The load balancing module 12e selects a server in the *.cgi group 110 based on its stored available capacity information of other servers in the cluster 110, particularly servers 10a and 10b. For example, if the server 10a has greater available capacity than the server 10b, then the server 10e redirects the client's connection to server 10a using a TCP/IP connection protocol, UDP protocol, or other comparable IP level protocol.

Alternatively, the original server may redirect the client request to the destination server to maintain a persistent session with a particular server. The destination server can be identified using cookies and SSL tags. It is appreciated that this can be used to limit a client access to particular servers or to maintain data integrity by allowing the client to access the content or data from the same content source, i.e., from the same server.

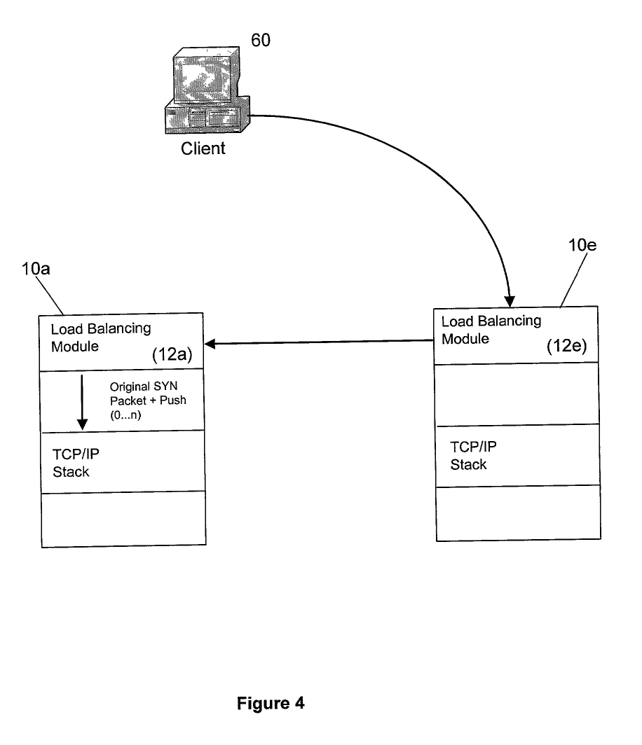

A technique of redirecting a connection from one server to another in accordance with an embodiment of the present invention is shown in FIG. 4. The load balancing modules of the original and destination servers process or control the tasks involved in redirecting the connection. The redirection process is described in conjunction with the FIGS. 3 and 4. The load module 12e initially accepts the client request and establishes a connection with the client 60. If the load module 12e determines that another load module within the cluster 100, such as the load module 12a, is better suited to provide the requested content, then the load module 12 transmits the client's connection information to the load module 12a and terminates its connection with the client 60.

In other words, if the load balancing module 12e determines that another server in the cluster 100, such as the destination server 10a, should continue with the established connection or conversation, the load balancing module 12e transmits the information indicative of the client's connection, such as the PUSH( ) data packet, the source IP, the source port, and a sequence number of the SYN packet, to the destination server 10a. The load balancing module 12a of the destination server 10a uses the packets received from the original server 10e to alter the state of its TCP/IP stack, thereby replicating the state of server 10e.

More specifically, the load balancing module 12a uses the information received from server 10e to generate a SYN packet having a source IP, source port and SYN sequence number identical to the SYN packet originally received by the server 10e. In accordance with an embodiment of the present invention, the newly generated SYN packet appears to the server 10a as if it originated from the client 60 and is passed or injected into the TCP/IP stack of the server 10a. The TCP/IP stack attempts to reply with a SYN/ACK packet, but the load balancing module 12a intercepts and discards the SYN/ACK packet. Consequently, the supplied data packets (PUSH) are injected into the TCP/IP stack of the destination server 10a and the destination server 10a is effectively brought into synch with the original server 10e, with respect to the connection with the client 60. Once the connection is successfully redirected and the destination server 10a is in synch with the original server 10e, the original server 10e terminates its connection with the client 60. In accordance with an aspect of the present invention, the load module 12e can push or inject a FIN( ) packet into the TCP/IP stack of the server 10e to terminate the connection between the server 12e and the client 60. In response to the FIN( ) packet, the TCP/IP stack generates and transmits a FIN/ACK reply, which is intercepted and discarded by the load balancing module 12e.

### Choosing a Destination Server

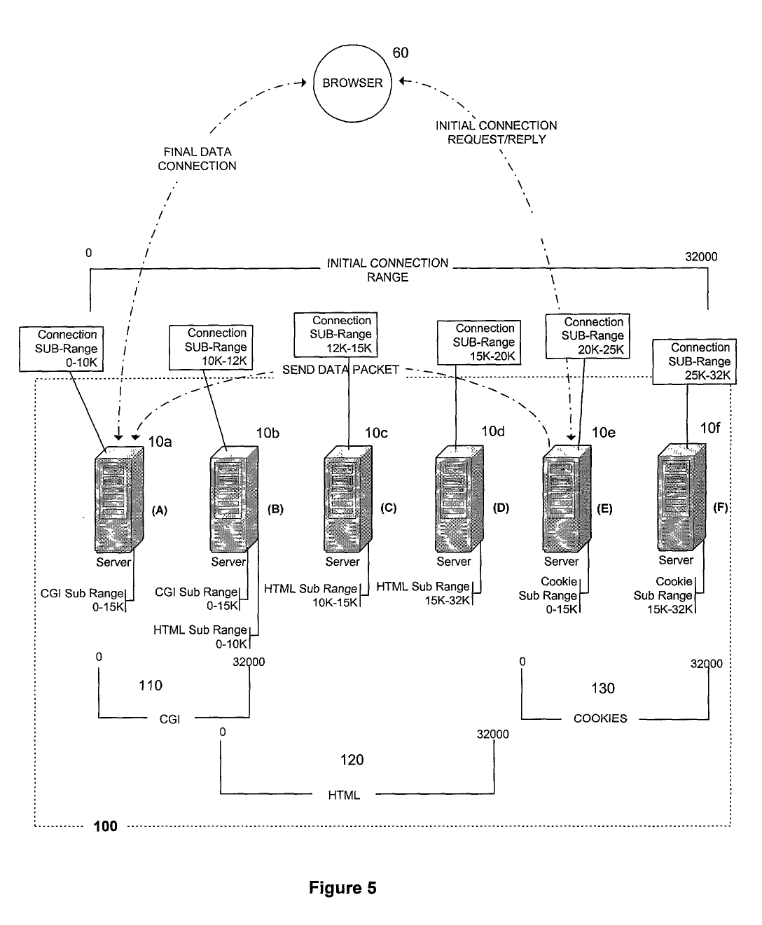

Turning now to FIG. 5, there is illustrated a technique for determining the destination server to redirect the client's connection by the original server in accordance with an embodiment of the present invention. The original server that has accepted and established a connection with a client 60 may determine for one of several reasons that another server in the cluster 100 is better suited to handle the client's request. For example, the original server may redirect a client's connection if it does not have the requested content or the latest version of the requested content. If the client 60 requests CGI content, the original server 10e of FIG. 5 belonging to the cookie server group 130 will likely redirect the client's connection since it does not have the requested content type. Therefore, the load balancing module 12e must determine or evaluate which other server 10 in the cluster 100 can provide the requested content to the client 60. Each load balancing module 12 includes a record or information regarding the data format(s) of all the server groups in the cluster 100. Accordingly, the load balancing module 12e utilizes its stored data format information to determine that servers 10a and 10b are likely to contain the requested CGI content. Once the original server 10e determines which server group to redirect the client's connection, the original server 10e selects a particular server within that group based on certain parameters, such as the available capacity of the servers, etc. According to an aspect of the present invention, the original server 10e redirects the client's connection to a server having the highest available capacity in the appropriate destination server group.

In accordance with an embodiment of the present invention, the original server multicasts a redirection packet to each server in the destination group. Each server in the group is assigned another range of connection values as a function of its available capacity in relation to the overall available capacity of the group. That is, each server is assigned a range of connection values based on its available capacity in relation to the overall available capacity of the cluster (i.e., at the cluster level) and another range based on its available capacity in relation to the overall capacity of the group (i.e., at the group level). As illustrated in FIG. 5, the server 10f belonging to the cookie group 130 has connection values 25,001 to 32,000 with respect to the cluster 100 and 15,001 to 32,000 with respect to the cookie group 130. Also, a server belonging to multiple groups has a multiple range of connection values at the group level. For example, in FIG. 5, the server 10b belonging to both the *.cgi group 110 and the *.html group 120 has two range or sets of connection values at the group level, connection values 15,001 to 32,000 for the *.cgi group and 0 to 10,000 for the *.html group. Upon receiving the redirection packet, each server in the destination group performs an identical hashing function on a portion of the redirection packet, such as the header, to generate a second connection value. The server in the destination group that is assigned the second connection value accepts the redirection packet and establishes a connection with the client 60.

In accordance with another embodiment of the present invention, the original server 10 utilizes a hashing function to select the appropriate server in the destination server group. For example, the original server maintains a group level table containing the range of connection values that are assigned to each server in the destination group. That is, the original server performs a second hashing function to generate a second connection value, and redirects the connection to the server in the destination group that is assigned the second connection value.

### Content Distribution and Availability

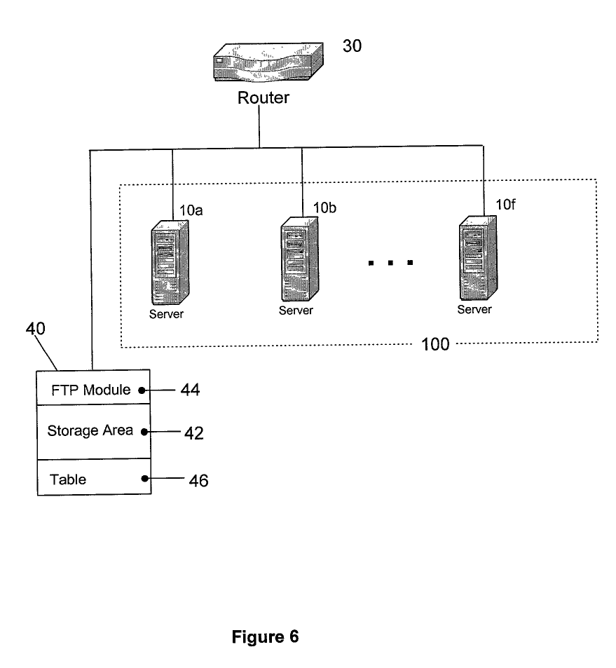

Turning now to FIG. 6, there is illustrated a content distribution system 40 connected to the server cluster 100 via the router 30 in accordance with an embodiment of the present invention. The content distribution system 40 includes a storage area 42 for storing content to be distributed to the servers 10 and a File Transfer Protocol (“FTP”) module 44 for transporting a copy of the stored content from the storage area 42 to each server 10 in the cluster 100 via the router 30. The content distribution system 40 also includes an update table 46 for storing records that indicate the status of each content distributed to each server 10 in the cluster 100.

During the file transfer process, i.e., when the FTP module 44 copies (or updates) a particular content from the storage area 42 to one or more servers 10 in the cluster 100, the content distribution system 40 changes the corresponding records in the update table 46 to indicate that the content being updated is currently “unavailable” on those servers. Accordingly, for example, when a load balancing module 12e of the server 10e (FIGS. 3 and 5) selects an appropriate destination server for redirecting a connection request for specific content, the load balancing module 12e examines the update table 46 to determine if the requested content is “unavailable” on any server and disregards or ignores all such servers in its selection process. Preferably, the content distribution system 40 updates only a subset of the servers in a server group at any given time, thereby always providing at least one server from each group to process clients' requests even if the requested content is currently being updated by the FTP module 44. Once a predetermined or threshold number of servers are updated with a new version of the content, the content distribution system 40 modifies the corresponding records in the update table 46 to indicate that the servers containing the old version of the content are “unavailable”. It is appreciated that the threshold number can be any value from 5% to 95% of the total number of servers being updated.

Each time a particular content is copied to a specific server by the FTP module 44, the content distribution system 40 modifies the corresponding record to indicate the status change of that particular content with respect to that specific server. In accordance with an embodiment of the present invention, the record is changed to indicate that the content is now “available.” Preferably, the record also indicates the “freshness,” the date and time of the update, or the current version of the content, thereby enabling the load balancing module 12 to distinguish between servers having older and newer versions of the same content. It is appreciated that a record for a specific piece of content on a specific server can indicate the time and date the content was last updated or it can indicate a version value for that content. The standard convention is to assign a higher version value to the latest or newer version of the content. Therefore, a load balancing module 12 uses the update table 46 to select an original server or a destination server (for redirecting a client's connection) with the latest version of the content, i.e., a server corresponding to a record with the highest version value for said content.

While the present invention has been particularly described with respect to the illustrated embodiment, it will be appreciated that various alterations, modifications and adaptations may be made on the present disclosure, and are intended to be within the scope of the present invention. It is intended that the appended claims be interpreted as including the embodiment discussed above, those various alternatives, which have been described, and all equivalents thereto.

What is claimed:

1. A method for balancing connection load among servers in a heterogeneous server cluster, comprising the steps of:
determining by each server in said cluster whether a connection request having at least information regarding a requested content can be accepted;
accepting said request by a server if it is determined that said server can accept said request;
reading said request to determine if said requested content resides in said server;
redirecting said request to another server if it is determined that said content does not reside in said server.

2. The method of claim 1, further comprising the step of assigning a non-overlapping range of connection values from a plurality of connection values to each server in said cluster, said plurality of connection values being associated with said cluster; and wherein the step of determining includes the step of generating a connection value for said request; and wherein the step of accepting includes the step of selecting a server associated with said connection value.

3. The method of claim 2, wherein the step of assigning includes the steps of:
determining an available capacity of each server in said cluster and an overall available capacity of said cluster;
determining a proportional available capacity of said each server with respect to said overall available capacity; and
assigning a range of connection values to said each server in accordance with said proportional available capacity of said each server.

4. The method of claim 2, wherein said connection value is a substantially random number selected from said plurality of connection values.

5. The method of claim 2, wherein said request comprises at least one data packet; and wherein the step of generating performs a hashing function on a predefined portion of said data packet to generate said connection value for said request.

6. The method of claim 1, further comprising the step of grouping said servers in said cluster in accordance with stored content format of said servers to form one or more groups, wherein each server in a group contains substantially identical content.

7. The method of claim 6, wherein the step of redirecting includes the step of selecting a destination group in said cluster in accordance with said requested content.

8. The method of claim 7, wherein the step of redirecting includes the steps of:
assigning a non-overlapping range of group connection values from a plurality of group connection values to each server in said destination group;
generating a group connection value for said request; and
selecting a destination server in said destination group associated with said group connection value.

9. The method of claim 8, wherein the step of assigning group connection values includes the steps of:
determining an available capacity of each server in said group and an overall available capacity of said destination group;
determining a proportional available capacity of said each server in said group with respect to said overall available capacity of said destination group; and
assigning a range of group connection values to said each server in said group in accordance with said proportional available capacity of said each server in said destination group.

10. The method of claim 7, further comprising the step of storing records in an update table, each record having at least a version value of each content residing in each server in said cluster.

11. The method of claim 10, wherein the step of redirecting includes the step of:
reading records corresponding to said requested content for each server in said destination group; and
selecting said destination server in said destination group with the highest version value for said requested content.

12. The method of claim 10, wherein said record further includes availability information of said requested content; and wherein the step of selecting includes the steps of determining if said requested content is unavailable from any server in said destination group to provide unavailable servers and inhibiting the selection of said unavailable servers as said destination server.

13. A distributed system for balancing connection load among servers in a heterogeneous server cluster, comprising:
a plurality of servers, each server comprising:
a receiving module for receiving a connection request from a client, each request having at least information regarding a requested content;
a load balancing module for determining whether said request can be accepted by said server and designating said server as a first server if it is determined that said server can accept said request;
a reading module for reading said request to determine if said requested content resides in said first server; and
wherein said load balancing module of said first server is operable to redirect said request to a second server in said cluster if it is determined that said content does not reside in said first server.

14. The system of claim 13, wherein said cluster being associated with a plurality of connection values; wherein each server being assigned a non-overlapping range of connection values from said plurality of connection values; and wherein said load balancing modules are operable to generate a connection value for said request to determine which server is associated with said connection value to determine said first server.

15. The system of claim 14, wherein each server includes an agent for determining an available capacity of said server, broadcasting said available capacity to said plurality of servers in said cluster, and determining an overall available capacity of said cluster; and wherein said range of connection values being assigned to a server as a function of said available capacity of said server and said overall available capacity of said cluster.

16. The system of claim 14, wherein said connection value is a substantially random number selected from said plurality of connection values.

17. The system of claim 14, wherein said request comprises at least one data packet; and wherein said load balancing modules are operable to perform a hashing function on a predefined portion of said data packet to generate said connection value for said request.

18. The system of claim 13, wherein said servers in said cluster are grouped in accordance with stored content format of said servers to form one or more groups, wherein each server in a group contains substantially identical content.

19. The system of claim 18, wherein said load balancing module of said first server is operable to select a destination group in said cluster in accordance with said requested content.

20. The system of claim 19, wherein said destination group being associated with a plurality of group connection values; wherein each server in said destination group being assigned a non-overlapping range of connection values from said plurality of connection values; and wherein said load balancing modules are operable to generate a group connection value for said request to determine which server in said destination group is associated with said group connection value to determine said second server.

21. The system of claim 20, wherein each server in said destination group includes an agent for determining an available capacity of said server, broadcasting said available capacity to said servers in said destination group, and determining an overall available capacity of said destination group; and wherein said range of group connection values being assigned to a server in said destination group as a function of said available capacity of said server and said overall available capacity of said destination group.

22. The system of claim 19, further comprising an update table for storing records, each record having at least a version value of each content residing in each server in said cluster.

23. The system of claim 22, wherein said load balancing module of said first server is operable to read records corresponding to said requested content for each server in said destination group from said update table and select said second server in said destination group with the highest version value for said requested content.

24. The system of claim 22, wherein said record further includes availability information of said requested content; and wherein said load balancing module of said first server is operable to determine if said requested content is unavailable from any server in said destination group to provide unavailable servers and to inhibit the selection of said unavailable servers as said second server.

25. A method for balancing connection load among servers in a heterogeneous server cluster, comprising the steps of:
determining by each server in said cluster whether a connection request having at least information regarding a requested content can be accepted;
accepting said request by a server if it is determined that said server can accept said request;
reading said request to determine if a latest version of said requested content resides in said server;
redirecting said request to another server if it is determined that the latest version of said content does not reside in said server.

26. A distributed system for balancing connection load among servers in a heterogeneous server cluster, comprising:
a plurality of servers, each server comprising:
a receiving module for receiving a connection request from a client, each request having at least information regarding a requested content;
a load balancing module for determining whether said request can be accepted by said server and designating said server as a first server if it is determined that said server can accept said request;
a reading module for reading said request to determine if a latest version of said requested content resides in said first server; and
wherein said load balancing module of said first server is operable to redirect said request to a second server in said cluster if it is determined that the latest version of said content does not reside in said first server.
